(19) United States
(12) Patent Application Publication
(10) Pub. No.: US 2004/0102345 A1
(43) Pub. Date: May 27, 2004

(54) Solid wrinkle reduction laundry product compositions containing hydrophilic oil derivatives

(75) Inventors: Michael Orchowski, East Rutherford, NJ (US); Dennis Stephen Murphy, Wyckoff, NJ (US); Feng-Lung Gordon Hsu, Tenafly, NJ (US); Daniel Joseph Fox, Tenafly, NJ (US); John Brockett, Wantagh, NY (US); David Alan Binder, Saddle Brook, NJ (US)

Correspondence Address: UNILEVER, PATENT DEPARTMENT, 45 RIVER ROAD, EDGEWATER, NJ, 07020, US

(73) Assignee: Unilever Home and Personal Care USA, Division of Conopco, Inc.

(21) Appl. No.: 10/301,933

(22) Filed: Nov. 22, 2002

(51) Int. Cl. C11D 1/00

(52) U.S. Cl. 510/256

(57) ABSTRACT

A laundry detergent product produced by a spray-on process and method of laundering clothes is disclosed which relates to the inclusion of one or more wrinkle reducing ingredients in the laundry detergent product. The spray-on process produces a freely flowable powder or granular laundry products that incorporate effective amounts of hydrophilic wrinkle reducing ingredients. The benefits are delivered to the laundered item during the cleaning step and, therefore, reduces the need for further wrinkle reducing steps when the items are taken from the dryer or after hang drying.

### BACKGROUND OF THE INVENTION

1. Field of the Invention

The present invention relates to a solid laundry detergent composition suitable for laundering textiles, such as clothing, linens and the like. In particular, it relates to a solid laundry detergent composition containing water soluble or dispersible triglyceride oil derivatives that are sprayed on the solid composition whereby the use of the product causes textile wrinkles to be eliminated or minimized after the cleaning and drying process.

2. The Related Art

Applicants have disclosed wrinkle reduction laundry product compositions in U.S. Pat. No. 6,426,328 to Murphy et al., issued on Jul. 30, 2002; U.S. Pat. No. 6,403,548 to Murphy et al., issued on Jun. 11, 2002; and in the following copending U.S. applications: U.S. Ser. Nos. 09/995131, 10/131110, and 10/146732. It is further known to coat antifoam compounds such as silicone oil onto detergent powders and granules at levels of approx. 0.1% -1% by wt. For example, U.S. Pat. No. 4,419,260 to Reuteret al issued on Dec. 6, 1983 describes a method for adding silicone antifoam compounds to detergents by spray drying a slurry mixture containing detergent ingredients and a separately-produced dispersion containing water, a silicone antifoam and a polymer to form microcapsules to produce detergents comprising 0.1% to 0.13% silicone oil. U.S. Pat. No. 4,264,465 to Heinz issued on Apr. 29, 1982 discloses a process for preparing detergents comprising water insoluble silicone antifoam compounds by treating either a pulverescent, surfactant-free detergent component with a composition consisting of a silicone antifoam and a volatile solvent along with the use of dispersing agents to yield an acceptably divided form. PCT publication no. WO 0002982(A2,A3) to Bettiol et al. published on Jan. 20, 2000 discloses detergent compositions that contain silicone antifoam compounds in conjunction with a siloxane-oxyethylene copolymer as a required dispersing agent for spray-on application. PCT publication no. WO 9913040(A1) to Guedira In et al. published on Mar. 18, 1999 describes the use of suds-suppressing systems in laundry detergent powders and suggests that a mixture of dry PDMS and a siloxane-oxyethylene copolymer dispersing agent may be blended with the powder detergent.

Surprisingly it has been found that hydrophillically modified triglyceride or silicone oils, that are either water-soluble or water-dispersible, and are soluble or dispersible in the surfactants used in laundry detergent powders, including those that are commercially available as aqueous solutions or dispersions, yield a dry, non-tacky, free-flowing powder or granular composition when applied to a fully-formulated detergent powder comprising a substantial amount of bound water (i.e. a range of about 4 to 20%, preferably about 6 to 14%, and more preferably about 8 to 12% by weight of water based on the total weight of the detergent powder).

### SUMMARY OF THE INVENTION

In one aspect, the present application relates to a free flowing powdered laundry detergent composition, comprising:

a. at least one water soluble or dispersible wrinkle reducing agent selected from hydrophilically modified animal oils; hydrophilically modified synthetic oils; hydrophilically modified vegetable oils; hydrophilically modified silicone oils and blends thereof; wherein said wrinkle reducing agent is present in an amount effective to reduce the occurrence of wrinkles in laundered clothing;

b. wherein the detergent composition is produced by a process including the steps of;

1. selecting a powdered detergent composition;

2. selecting an aqueous solution or dispersion of one or more of the water soluble or dispersible wrinkle reducing agents (preferably the wrinkle reducing agent is in a concentration range of about 10 to 99% by wt., more preferably about 25 to 90% by wt. of the aqueous solution ) or a neat hydrophilic wrinkle reducing agent;

3. agitating the powdered detergent in a coating vessel so that the mean particle size of the powdered detergent is in the range of about 30 to 2000 microns;

4. spray coating the suspended/agitated powdered detergent with a finely dispersed neat or aqueous solution or dispersion of one or more wrinkle reducing agents (preferably atomized to a particle size range of about 1 to 300 microns, more preferably about 2 to 100 microns)

5. allowing the neat or aqueous wrinkle-reducing agent to adsorb into the powder, and optionally adding an anti-caking agent or drying the slurry for less than 20 minutes at a temperature between 26.7 C and 77 C or until the detergent reaches a specific moisture content (preferably about 2% to 12% moisture).

The term “neat” is used herein to represent a wrinkle reduction material or a blend of other wrinkle reduction materials that are not dissolved or dispersed in another substance that does not have wrinkle reduction properties. Neat materials will be substantially free of organic solvents, especially volatile organic solvents with a boiling point of less than 100 C which may be hazardous, toxic, or both. Advantageously the inventive process produces a free flowing powdered or granulated laundry detergent composition that has substantially reduced tackiness (as determined by art recognized techniques such as gravimetric analysis described below), thus enabling the solid detergent to be free flowable. Preferably the wrinkle reducing agent is selected from a triglyceride oil, a silicone oil, or a blend thereof.

In another aspect of the present invention is a method of reducing the occurrence of wrinkles in laundered clothing, comprising the steps of:

a. providing a detergent composition including at least one surfactant and at least one water soluble or dispersible wrinkle reducing agent selected from hydrophilically modified animal oils; hydrophilically modified synthetic oils; hydrophilically modified vegetable oils; hydrophilically modified silicone oils and blends thereof; wherein said wrinkle reducing agent is present in an amount effective to reduce the occurrence of wrinkles in laundered clothing;

b. wherein the detergent composition is produced by a process including the steps of;

1. selecting a powdered detergent composition (preferably having a water content of greater than 2% by wt., more preferably greater than 5% by wt.);

2. selecting an aqueous solution or dispersion of one or more of the water soluble or dispersible wrinkle reducing agents (preferably the wrinkle reducing agent is in a concentration range of about 10 to 99% by wt., more preferably about 25 to 90% by wt. the aqueous solution) or a neat hydrophilic wrinkle reducing agent or blend of neat wrinkle reducing agents;

3. agitating the powdered detergent in a coating vessel so that the mean particle size of the powdered detergent is in the range of about 30 to 2000 microns;

4. spray coating the suspended/agitated powdered detergent with a finely dispersed neat or aqueous solution or dispersion of one or more wrinkle reducing agents (preferably atomized to a particle size range of about 1 to 200 microns, more preferably about 2 to 100 microns)

5. allowing the neat or aqueous wrinkle-reducing agent to adsorb into the powder, and optionally adding an anti-caking agent or drying the slurry for less than 20 minutes at a temperature between 26.7 C and 76.7 C or until the detergent reaches a specific moisture content (preferably about 2 to 12% moisture).

c. contacting the detergent composition with clothing during a washing procedure; and

d. allowing the clothing to dry; wherein the laundered clothing has fewer wrinkles present than clothing laundered and dried in an identical manner with a detergent composition that excludes the at least one wrinkle reducing agent.

### DETAILED DESCRIPTION

In one aspect of the invention, the inventive laundry detergent composition preferably has about 10 to 60 wt. % of a surfactant and is coated with the wrinkle reducing agent in the concentration range of about 1 to 30% by wt., preferably in the range of about 0.5 to 15% by wt. of the composition, and more preferably in the range of about 1 to 7% by wt. of the composition.

In another aspect of the invention is a method for reducing the occurrence of wrinkles in laundered clothing, wherein the detergent composition is in a form selected from a powder, granule, tablet and molded solid and is produced by the inventive process.

Advantageously, the inventive composition includes a wrinkle reducing agent selected from hydrophilically-modified plant, animal and synthetic triglyceride oils, and silicone oils.

Suitable and preferred hydrophilically modified plant, animal, and synthetic triglyceride oils and waxes have been identified for wrinkle reduction benefits when included in the known powder, granular and solid form detergent compositions according to the present invention. Such suitable plant derived triglyceride materials include hydrophilically modified triglyceride oils, e.g. sulfated, sulfonated, carboxylated, alkoxylated, esterified, saccharide modified, and amide derivatized oils, tall oils and derivatives thereof, and the like. Suitable animal derived triglyceride materials include hydrophilically modified fish oil, tallow, lard, and lanolin wax, and the like.

Various levels of derivatization may be used provided that the derivatization level is sufficient for the oil or wax derivatives to become water soluble or dispersible so as to exert a wrinkle reduction effect during laundering of fabrics with a detergent containing the oil or wax derivative.

Suitable sulfated plant and animal derived and synthetic triglyceride oil derivatives are illustrated in the following structure:

TG−(OSO₃M )ₙ (1)

TG=Triglyceride radical;

n=1, 2 or 3;

M is H or a cation such as Na, K, Li, NH₄, Ca, or Mg and the like.

Suitable sulfonated plant and animal derived and synthetic triglyceride oil derivatives are illustrated in the following structure:

TG−(SO₃M)ₙ (2)

TG=Triglyceride radical;

n=1, 2 or 3;

M is H or a cation such as Na, K, Li, NH₄, Ca, or Mg and the like.

With respect to triglyceride oil derivatives (1) and (2) sulfation and sulfonation preferably occurs either across a double bond or at a hydroxyl position.

Suitable alkoxylated plant and animal derived and synthetic triglyceride oil derivatives are illustrated in the following structure:

TG−((OCH₂CH₂O)_{X}(OCHCH₃CH₂)_{Y}OR)ₙ (3)

TG=Triglyceride radical;

n=1, 2 or 3;

R═H; C₁-C₂₀ alkyl, C₁-C₂₀ alkenyl, C₁-C₂₀ alkylaryl, aryl, or heterocyclic; either substituted or unsubstituted.

x=an integer from 1 to 50; y=an integer from 0 to 50; x and y groups may be in either a random or a blocked arrangement.

Suitable saccharide modified plant and animal derived and synthetic triglyceride oil derivatives may include monosaccharides, disaccharides and polysaccharides e.g. sucrose, glucose, maltose and the like, or a combination thereof as illustrated in the following structure:

TG−(Saccharide)ₙ (4)

TG=Triglyceride radical;

n=1, 2 or 3.

Suitable carboxylated plant and animal derived and synthetic triglyceride oil derivatives may include compounds as illustrated by the following structure:

TG−(C(O)(CH₂)_{z}C(O)OM)ₙ (5)

TG=Triglyceride radical;

n=1, 2 or 3;

z is an integer from 1 to 20, preferably from 1 to 5.

M is H or a cation such as Na, K, Li, NH₄, Ca, or Mg and the like.

Suitable peptide modified plant and animal derived and synthetic triglyceride oil derivatives may include monopeptides, dipeptides, and polypeptides as illustrated by the following structure:

TG−(peptide(s))ₙ (6)

TG=Triglyceride radical;

n=1, 2 or 3.

Suitable commercially available sulfated triglyceride oils include sulfated canola oil or Freedom Scano 75 available from-Noveon (Cleveland, Ohio). Suitable commercially available ethoxylated and alkoxylated derivatives include: castor oil products such as Stepantex CO-30, Stepantex CO-36 and Stepantex CO-40 ethoxylated castor oil products and Stepantex HCO-5 a hydrogenated castor oil alkoxylate, the Ethox CO line of products (ethoxylated castor oil), and the like, from Ethox Chemicals (Greenvile, S.C.) and the Hetoxide C line of products (ethoxylated castor oil), and the like, from Heterene Chemical (Paterson, N.J.); tall oil derivatives such as Ethofat 242/25, an ethoxylated tall oil, and the like, available from Akzo Nobel; and lanolin derivatives such as Lan-Aqua-Sol 4:50 (lanolin ethoxylate) and Fancol HL-20 (a hydrogenated lanolin ethoxylate), and the like.

Suitable triglyceride oil derivatives may be prepared by esterification to a sufficient level for the triglyceride oil derivatives to become water soluble or dispersible so as to exert a wrinkle reduction effect during laundering of fabrics with a detergent containing the esterified triglyceride oil derivative. Any suitable compound may be used to esterify the triglyceride oil including linear, alpha-omega dicarboxylic acids.

Other suitable derivatives include Freedom STW-80 (sulfated tallow), Solocod G (sulfated fish oil), and Freedom SLO-75 (sulfated lard oil) , and the like, available from Noveon (Cleveland, Ohio); Lowenol NZB (sulfated lanolin), and the like, available from Lowenstein and Sons (Brooklyn, N.Y.); and, Fancol ACEL (acylated lanolin), and the like, available from Thornley Co (Wilmington, Del.).

If a plant, animal or other triglyceride oil is used, preferably it is present at a weight level between about 10 and 99% by wt., more preferably about 20 and 90%, of the composition sprayed onto the detergent product. Neat oils and oil blends may also be sprayed directly onto the product, although for environmental and safety reasons, in all cases the material sprayed on will advantageously be substantially free of organic solvents. To minimize energy consumption, it is highly preferred that the oil used have a viscosity of less than 1,000 cP at 25C, although other oils may also be either melted prior to application or dispersed in water to render them sprayable. The preferred finished detergent products produced via this invention, when it comprises a plant, animal or other triglyceride oil, contain between about 0.5% and 15% wrinkle-reduction agent, whereas the most preferred compositions contain between about 1 and 7% wrinkle-reduction agent.

Suitable hydrophilically modified silicone oils and waxes have also been identified for wrinkle reduction benefits when included in known powder, granular and solid form detergent compositions according to the present invention. Such suitable silicone materials include polyalkyleneoxide modified polydimethylsiloxane, linear aminopolydimethylsiloxane polyalkyleneoxide copolymers, betaine siloxane copolymers and alkyllactam siloxane copolymers.

If a silicone oil is used, it is preferably either a silicone poly ether or amino-functional silicone. Preferably the silicone poly ether has one of the two general structures shown below:

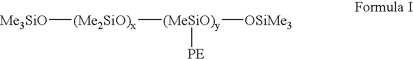

Formula II

(MeSi)_{y-2}—[(OSiMe₂)_{x/y}OPE]_{y}

Where PE represents:

CH₂—CH₂—CH₂—O—(EO)ₘ—(PO)ₙ-Z

and Me represents methyl, EO represents ethylene oxide, PO represents 1,2 propylene oxide, Z represents either a hydrogen or a lower alkyl radical, x,y,m and n are constants and can be varied to alter the properties of the functionalized silicone.

A molecule of either structure can be used for the purposes of this invention. Preferably, this molecule contains more than about 30% silicone, more than about 20% ethylene oxide and less than about 30% propylene oxide by weight, and has a molecular weight of more than about 5,000. An example of a suitable, commercially available such material is L-7622, available from Crompton Corporation (Greenwich, Conn.).

Amino-functional silicones come in a wide variety of structures, which are well-known to those skilled in the art. These are also useful in the context of this 10 invention, although over time many of these materials can oxidize on fabrics, leading to yellowing. As this is not a desirable property of a fabric care composition, if an amino-functional silicone is used, preferably it is a hindered amine light stabilized product, which exhibits a greatly reduced tendency to show this behavior. A commercially available example of such a silicone is Hydrosoft, avalaible from Rhodia—US (Cranbury, N.J.).

If a silicone oil is used, preferably it is present at a weight level between about 10 and 99% by wt., more preferably about 20 and 90%, of the composition sprayed onto the detergent product. The preferred finished detergent products produced via this invention, when it comprises a silicone, contain between about 0.5% and 15% silicone wrinkle-reduction agent, whereas the most preferred compositions contain between about 1 and 7% silicone wrinkle-reduction agent. Preferably, said agent is present as a water-in-oil microemulsion, although other types of aqueous dispersions, such as oil-in water microemulsions, water-in-oil emulsions and oil-in-water emulsions, are also acceptable for use with this invention. Neat hydrophilically-modified silicone oils may also be used to spray-coat the composition. In all cases when a silicone oil used, the composition spray-coated onto the detergent is advantageously substantially free of organic solvents for safety and environmental reasons. Blends of neat silicone and triglyceride oils may also be used.

Except in the operating and comparative examples, or where otherwise explicitly indicated, all numbers in this description indicating amounts of material ought to be understood as modified by the word “about”.

The following examples will more fully illustrate the embodiments of this invention. All parts, percentages and proportions referred to herein and in the appended claims are by weight unless otherwise illustrated. Physical test methods are described below:

### TEST METHOD AND EXAMPLES

Wrinkle reduction may be measured by using the American Association of Textile Chemists and Colorists' (AATCC) method # 124, Appearance of Fabrics after Repeated Home Laundering in order to assess the benefits of the invention. In this method, four cloth types (silk, rayon, cofton, and linen) are washed, dried and stored in a well defined way. The dried cloths are then evaluated for wrinkle content by comparison with wrinkle smoothness replicas which can be purchased from AATCC. Factors such as the light used, the angle of the cloths and replicas to the light, and the background are carefully controlled and described in the method. There are six replicas with values of 1, 2, 3, 3.5, 4, and 5 with 5 being perfectly smooth and 1 being very wrinkled. Three trained observers are asked to give a value of 1-5, to the nearest 0.5 unit, to each cloth based on which replica it most closely resembles. The results are totaled and averaged over the three observers for each cloth type. According to the method, a difference of greater than 0.17 between the results for two products indicates there is a significant difference at the 95% confidence level. A difference of greater than or equal to 0.25 indicates a significant difference at the 99% confidence level.

Tackiness and flowability of the powder may be measured by evaluating the flowability of the powder through a #10 sieve. Acceptable sieves can be ordered from many manufacturers, such as the Newark Wire Cloth Company (Newark, N.J.). A suitable shaking instrument for this test can be ordered as Model RX-86 from the W.S. Tyler Company (Mentor, Ohio). For the purposes of this disclosure, any powder where 85% of its mass can be passed through a #10 sieve after 3 minutes of agitation on an RX-86 shaker shall be considered “non tacky.”

The following examples of compositions show preferred ranges of ingredients in accordance with the present disclosure. Compositions 1 and 2 represent powdered and tableted detergent compositions respectively.

### Example 1

The following detergent powder compositions containing an inventive wrinkle reduction ingredient may be produced according to the inventive process described below:

Composition 1 (Detergent Powder)

| | Percent in Formula (Based on 100% |
|---|---|
| Ingredient - Chemical Name | Active Raw) |
| Ethoxylated nonionics | 2.0-20.0 |
| Alkylbenzene sulfonic acid | 4.0-20.0 |
| Sodium hydroxide | 1.0-8.0 |
| Sodium aluminosilicate | 15.0-40.0 |
| Sodium carbonate | 15.0-30.0 |
| Sodium sulfate | 10.0-30.0 |
| Sodium silicate | 0.1-3.0 |
| Antiredeposition agent | 0-3.0 |
| Sodium perborate | 0-8.0 |
| Protease enzyme | 0-2.0 |
| Fragrance | 0.1-1.5 |
| Fluorescent whitening agent | 0-2.0 |
| Wrinkle reducing agent* | 0.5-15.0 |
| Water | To 100 |

*Selected from: Ethox CO-16 (POE-16 castor oil) and Ethox CO-25 (POE-25 castor oil) both available from Ethox Chemical Co.; Freedom STW-80 (sulfated tallow), Solocod G (sulfated fish oil), and Freedom SLO-75 (sulfated lard oil) available from Noveon; Lowenol NZB (sulfated lanolin) available from Lowenstein and Sons; Ethofat 242/25 (ethoxylated tall oil) available from Akzo Nobel; Lan-Aqua-Sol 4:50 (lanolin ethoxylate), Fancol HL-20 (hydrogenated lanolin
ethoxylates), Fancol ACEL (acylated lanolin) available from Thornley Co. and Freedom Scano 75 available from Noveon.

Typically one wash with a detergent prepared with and without the inventive wrinkle reducing agent is performed using approximately 50-90 g of powdered detergent in 17 gallons of water at 35 C.

### Example 2

The following detergent tablet compositions containing an inventive wrinkle reduction ingredient may be produced according to the inventive process:

COMPOSITION 2 (Detergent Tablet)

| | Percent in Formula (Based on 100% |
|---|---|
| Ingredient - Chemical Name | Active Raw) |
| Ethoxylated nonionics | 2.0-15.0 |
| Alkylbenzene sulfonic acid | 3.0-20.0 |
| Sodium Hydroxide | 1.0-8.0 |
| Sodium aluminosilicate | 15.0-40.0 |
| Sodium carbonate | 15.0-40.0 |
| Sodium sulfate | 2.0-10.0 |
| Sodium Acetate trihydrate | 15.0-40.0 |
| Fluorescent whitener | 0-2.0 |
| Stearic acid | 0.2-2.0 |
| Fragrance | 0.1-2.0 |
| Protease enzyme | 0-2.0 |
| Antiredeposition agent | 0-2.0 |
| Wrinkle reducing agent* | 0.5-15.0 |
| Water | to 100 |

*Selected from: Ethox CO-16 (POE-16 castor oil) and Ethox CO-25 (POE-25 castor oil) both available from Ethox Chemical Co.; Freedom STW-80 (sulfated tallow), Solocod G (sulfated fish oil), and Freedom SLO-75 (sulfated lard oil) available from Noveon; Lowenol NZB (sulfated lanolin) available from Lowenstein and Sons; Ethofat 242/25 (ethoxylated tall oil) available from Akzo Nobel; Lan-Aqua-Sol 4:50 (lanolin ethoxylate), Fancol HL-20 (hydrogenated lanolin
ethoxylates), Fancol ACEL (acylated lanolin) available from Thornley Co. and Freedom Scano 75 available from Noveon.

Typically one wash with a detergent prepared with and without the inventive wrinkle reducing agent is performed using 2 approximately 40 g detergent tablets in 17 gallons of water at 35 C.

The above-identified wrinkle reducing agents are incorporated in powdered/granular and molded solid or tablet compositions according to embodiments of the inventive process as described below.

### Example 3

40 lbs of a spray-dried powder laundry detergent composition with the following basic formula was charged to an O'Brien aggolmerator¹. ¹ Model# 36×18, available from O'Brien Industrial Equipment Co., San Francisco, Calif.

| COMPONENT | % WEIGHT |
|---|---|
| Water | 8.98 |
| Sodium Silicate | 0.45 |
| Sodium Polyacrylate | 0.45 |
| Sodium Alkylbenzenesulfonate | 12.38 |
| Alcohol Ethoxylate | 1.19 |
| Acrylate/Maleate Copolymer | 0.76 |
| Silicone | 0.01 |
| Zeolite (Anhydrous Basis) | 25.12 |
| Sodium Carbonate | 28.46 |
| Fluorescent Whitening Agent | 0.13 |
| Sodium Sulfate | 18.06 |
| Miscellaneous Solids | 0.35 |
| Alcohol Ethoxylate | 3.41 |
| Perfume | 0.25 |

In addition, 20 lbs of a 50% aqueous solution of sulfated castor oil² was added to a pressure pot, which was subsequently attached to a Teejet SS 6504 nozzle. This system was brought to a pressure of 60 psi using compressed air, and the agglomerator was turned on to yield a falling curtain of powder. Following this, the nozzle was turned on to periodically deliver short, fan-shaped bursts of sulfated castor oil solution to the powder over 30 minutes. 3.078 lbs of sulfated castor oil solution were added to the system, resulting in a largely free-flowing final composition containing an average of 3.572% wrinkle-reducing ingredient. The moisture content of the powder was approximately 11.9%. ² Freedom SCO-50, available from Noveon, Cleveland, Ohio.

### Example 4

135 g of a spray-dried powder laundry detergent composition with the following basic formula was charged to an open-ended rotary laboratory tumbler³. ³ Model #510, available from the A.E. Aubin Company, Marlborough, Conn.

| COMPONENT | % WEIGHT |
|---|---|
| Water | 8.98 |
| Sodium Silicate | 0.45 |
| Sodium Polyacrylate | 0.45 |
| Sodium Alkylbenzenesulfonate | 12.38 |
| Alcohol Ethoxylate | 1.19 |
| Acrylate/Maleate Copolymer | 0.76 |
| Silicone | 0.01 |
| Zeolite (Anhydrous Basis) | 25.12 |
| Sodium Carbonate | 28.46 |
| Fluorescent Whitening Agent | 0.13 |
| Sodium Sulfate | 18.06 |
| Alcohol Ethoxylate | 3.41 |
| Perfume | 0.25 |

56.1 g of an aminosilicone microemulsion⁴ was also added to a laboratory sprayer⁵, which was subsequently equipped with a “medium” spray nozzle and brought to 60 psi using compressed air. The tumbler was switched to the “on” position, after which the aminosilicone microemulsion was sprayed on the falling powder over the course of 30 minutes. 34.2 g of Rhodrsil Hydrosoft microemulsion, containing 6.84 g of active wrinkle-reduction agent, were delivered to the system, resulting in a free-flowing, non-tacky powder with an average loading of 4.04% wrinkle-reducing agent. ⁴ Rhodorsil Hydrosoft Microemulsion (20% active), Available from Rhodia—US, Cranbury, N.J. ⁵ Sure Shot Atomizer, available from the Milwaukee Sprayer Manufacturing Company, Milwaukee, Wis.

### Example 5

A free-flowing detergent powder may be created of the following formula by first spray drying, dry-mixing or agglomerating the ingredients excepting the wrinkle-reducing agent in the first step, and post-treating the composition with the wrinkle-reducing agent in the second step. The moisture content of the final free flowable powder may be in the range of about 2 to 12%.

| COMPONENT | % WEIGHT |
|---|---|
| Water | 0-15 |
| Wrinkle-reducing agent⁶ | 0.5-10 |
| Sodium Silicate | 0-10 |
| Soil Release and / or Anti-Ashing Polymer | 0-5 |
| Sodium Alkylbenzenesulfonate | 3-200 |
| Alcohol Ethoxylate | 0.5-10 |
| Zeolite (Anhydrous Basis) | 10-50 |
| Sodium Carbonate | 10-70 |
| Fluorescent Whitening Agent | 0-1 |
| Bleaching agent (sodium perborate or | 0-20 |
| percarbonate) | |
| Bleach activator | 0-5 |
| Enzymes | 0-2 |
| Sodium Sulfate | 0-30 |
| Miscellaneous Solids | 0.35 |
| Perfume | 0-2 |

⁶Selected from: Ethox CO-16 (POE-16 castor oil) and Ethox CO-25 (POE-25 castor oil) both available from Ethox Chemical Co.; Freedom STW-80 (sulfated tallow), Solocod G (sulfated fish oil), and Freedom SLO-75 (sulfated lard oil) available from Noveon; Lowenol NZB (sulfated lanolin) available from Lowenstein and Sons; Ethofat 242/25 (ethoxylated tall oil) available from Akzo Nobel; Lan-Aqua-Sol
4:50-(lanolin ethoxylate), Fancol HL-20 (hydrogentaed-lanolin ethoxylates), Fancol ACEL (acylated lanolin) available from Thornley Co., Silwet L-7622 (silicone polyether), available from OSi Specialty Chemicals and L-45 (polydimethylsiloxane), available from OSi Specialty Chemicals.

Suitable powdered/granular compositions are well known and commercially available, for example, under the brand names Wisk (Unilever) and Tide (Procter and Gamble).

While this invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the present invention.

We claim:

1. A free flowing powdered laundry detergent composition, comprising:
a. at least one water soluble or dispersible wrinkle reducing agent selected from hydrophilically modified animal oils; hydrophilically modified synthetic oils; hydrophilically modified vegetable oils; hydrophilically modified silicone oils and blends thereof;wherein said wrinkle reducing agent is present in an amount effective to reduce the occurrence of wrinkles in laundered clothing;
b. wherein the detergent composition is produced by a process including the steps of;
1) selecting a powdered detergent composition;
2) selecting either an aqueous solution or dispersion of one or more of the water soluble or dispersible wrinkle reducing agents, a neat hydrophilic wrinkle reducing agent, or a blend thereof;
3) agitating the powdered detergent in a coating vessel so that the mean particle size of the powdered detergent is in the range of about 30 to 2000 microns;
4) spray coating the suspended/agitated powdered detergent with a finely dispersed neat or aqueous solution or dispersion of one or more wrinkle reducing agents;
5) allowing the neat or aqueous wrinkle-reducing agent to adsorb into the powder, and optionally adding an anti-caking agent or drying the slurry to a moisture content of less than about 20% by wt.

2. The composition according to claim 1, wherein said laundry detergent composition has about 10 to 60 wt. % of a surfactant and is coated with the wrinkle reducing agent in the concentration range of about 1 to 30% by wt.

3. The composition according to claim 1, where at least one of the wrinkle reducing agents is present in the composition in the range of about 0.5 to 15 wt. % of the composition.

4. The composition according to claim 1, wherein at least one of the wrinkle reducing agents is present in the composition in the range of about 1 to 7 wt. % of the composition.

5. The composition according to claim 1 wherein the wrinkle reducing agent is selected from sulfated vegetable oil, sulfonated vegetable oil, carboxylated vegetable oil, alkoxylated vegetable oil, esterified vegetable oil, saccharide modified vegetable oil, amide derivatized vegetable oil, lanolin wax, ethoxylated lanolin, sulfated lanolin, sulfonated lanolin, sulfated fish oil, sulfonated fish oil, sulfated lard oil, sulfonated lard oil, ethoxylated tall oil, sulfated tall oil; sulfonated tall oil, sulfated tallow, sulfonated tallow, sulfated lard, sulfonated lard, polyalkyleneoxide modified polydimethylsiloxane, linear aminopolydimethylsiloxane polyalkyleneoxide copolymers, betaine siloxane copolymers alkyllactam siloxane copolymers, and derivatives and blends thereof.

6. A method of reducing the occurrence of wrinkles in laundered clothing, comprising the steps of:
a. providing a detergent composition including at least one surfactant and at least one water soluble or dispersible wrinkle reducing agent selected from hydrophilically modified animal oils; hydrophilically modified synthetic oils; hydrophilically modified vegetable oils; hydrophilically silicone oils and blends thereof; wherein said wrinkle reducing agent is present in an amount effective to reduce the occurrence of wrinkles in laundered clothing;
b. wherein the detergent composition is produced by a process including the steps of;
1) selecting a powdered detergent composition;
2) selecting an aqueous solution or dispersion of one or more of the water soluble or dispersible wrinkle reducing agents a neat hydrophilic wrinkle reducing agent, or a blend thereof;
3) agitating the powdered detergent in a coating vessel so that the mean particle size of the powdered detergent is in the range of about 30 to 2000 microns;
4) spray coating the suspended/agitated powdered detergent with a finely dispersed neat or aqueous solution or dispersion of one or more wrinkle reducing agents;
5) allowing the neat or aqueous wrinkle-reducing agent to adsorb into the powder, and optionally adding an anti-caking agent or drying the slurry for less than 20 minutes at a temperature between about 26.7 C and 77 C or drying the slurry to a moisture content of less than about 20% by wt;
c. contacting the detergent composition with clothing during a washing procedure; and
d. allowing the clothing to dry; wherein the laundered clothing has fewer wrinkles present than clothing laundered and dried in an identical manner with a detergent composition that excludes the at least one wrinkle reducing agent.

7. The composition according to claim 1 wherein the detergent composition is in a form selected from a powder, granule, tablet and molded solid.

8. A process for making a free flowable detergent composition containing a wrinkle reduction agent comprising the steps of:
a. selecting a powdered detergent composition;
b. selecting an aqueous solution or dispersion of one or more water soluble or dispersible wrinkle reducing agents;
c. agitating the powdered detergent in a coating vessel so that the mean particle size of the powdered detergent is in the range of about 30 to 2000 microns;
d. spray coating the suspended/agitated powdered detergent with a finely dispersed aqueous solution or dispersion of one or more wrinkle reducing agents;
e. allowing the aqueous wrinkle-reducing agent to adsorb into the powder, and
f. either adding an effective amount of an anti-caking agent to render the powder flowable or drying the slurry to a moisture content of less than about 20% by wt.
